(19) United States
(12) Patent Application Publication
(10) Pub. No.: US 2010/0034704 A1
(43) Pub. Date: Feb. 11, 2010

(54) MICROFLUIDIC CARTRIDGE CHANNEL WITH REDUCED BUBBLE FORMATION

(75) Inventors: Alex Gu, Plymouth, MN (US); Mark Washa, Plymouth, MN (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/187,101

(22) Filed: Aug. 6, 2008

(51) Int. Cl. B01L 3/02

(52) U.S. Cl. 422/100

(57) ABSTRACT

A microfluidic cartridge may have a microfluidic channel that is configured to reduce or eliminate bubble formation in liquids disposed within or flowing through the microfluidic channel. In some cases, the microfluidic channel may be considered as having a channel surface, and a polymeric coating or film may be disposed on the channel surface to help reduce or eliminate bubble formation in liquids disposed within or flowing through the channel. In some cases, the polymer coating or film may be formed from a block copolymer having a hydrophobic portion that bonds to the channel surface and a hydrophilic portion that reduces surface tension of the channel surface.

### TECHNICAL FIELD

The present disclosure pertains generally to microfluidic cartridges having microfluidic channels, and more particularly to microfluidic cartridges having microfluidic channels that are configured to reduce bubble formation.

### BACKGROUND

There has been a growing interest in the manufacture and use of microfluidic systems for the acquisition of chemical and biological information. Microfluidic systems often have a microfluidic cartridge that is capable of performing various microfluidic functions and/or analysis. For example, a microfluidic cartridge may be adapted to help perform sample analysis and/or sample manipulation functions, such as chemical, biological and/or physical analyses and/or manipulation functions. Microfluidic systems can have the advantage of, for example, shorter response time, smaller required sample volumes, lower reagent consumption, and in some cases, the capability to perform such analysis in the field. When hazardous materials are used or generated, performing reactions in microfluidic volumes may also enhance safety and reduces disposal quantities.

In some cases, a microfluidic cartridge is used in conjunction with a cartridge reader instrument. The cartridge reader instrument may, for example, provide support functions to the microfluidic cartridge. For example, and in some cases, a cartridge reader may provide electrical control signals, light beams and/or light detectors, pneumatic control flows, electric flow drive fields, signal processing, and/or other support functions, as desired. In many cases, the microfluidic cartridge may include one or more microfluidic channels through which various liquids such as reagents and/or a sample may flow. In some cases, fluid flow through such microfluidic channels may encourage the formation of bubbles. As can be imagined, bubbles may be detrimental to accurate sample analysis. A need remains, therefore, for a microfluidic cartridge having a microfluidic channel that is configured to reduce or eliminate bubble formation in liquids disposed within or flowing through the microfluidic channel and/or to improve flow patterns within the microfluidic channel.

### SUMMARY

The present disclosure pertains to a microfluidic cartridge having a microfluidic channel that is configured to reduce or eliminate bubble formation in liquids disposed within or flowing through the microfluidic channel. In some instances, the present disclosure pertains to a microfluidic cartridge having a microfluidic channel that is configured to provide improved flow patterns within the microfluidic channel.

An illustrative but non-limiting example of the disclosure may be found in a microfluidic cartridge that includes a channel for transporting a fluid from a first location within the microfluidic cartridge to a second location within the microfluidic cartridge. The channel may be considered as having a channel surface. A polymeric coating or film may be disposed on the channel surface to help reduce or eliminate bubble formation in liquids disposed within or flowing through the channel.

Another illustrative but non-limiting example of the disclosure may be found in a microfluidic cartridge that includes a polymeric substrate and a channel that is formed within the substrate. The channel may have a channel surface and may have a polymer film on the channel surface. In some cases, the polymer film may be formed from a block copolymer that includes a hydrophobic portion that bonds to the channel surface as well as a hydrophilic portion that reduces surface tension of the channel surface.

Another illustrative but non-limiting example of the disclosure may be found in a microfluidic cartridge that has a channel for transporting a fluid from a first location in the microfluidic cartridge to a second location in the microfluidic cartridge. The channel may be considered as including a channel surface and a polymeric coating that is disposed on the channel surface. An aqueous fluid may be disposed in or may be flowing through the channel such that the aqueous fluid is free or substantially free of bubbles.

The above summary is not intended to describe each disclosed embodiment or every implementation of the disclosure. The Description which follow more particularly exemplify these embodiments.

### BRIEF DESCRIPTION OF THE FIGURES

The following description should be read with reference to the drawings. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 is a schematic view of an illustrative but non-limiting microfluidic cartridge;

FIG. 2 is a cross-sectional view of the microfluidic cartridge of FIG. 1; and

FIG. 3 is a more detailed cross-sectional view of the microfluidic cartridge of FIG. 1.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

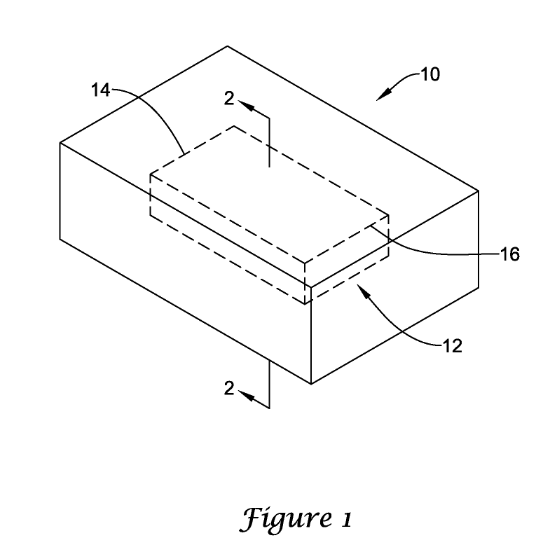

FIG. 1 is a schematic top view of an illustrative microfluidic cartridge in accordance with the present disclosure. It should be understood that the microfluidic cartridge shown generally at 10 is only illustrative, and that the disclosure pertains to any microfluidic cartridge regardless of form, function or configuration. For example, the microfluidic cartridge may be used for hematology, flow cytometry, clinical chemistry, electrolyte measurements, etc. It is also contemplated that the illustrative microfluidic cartridge 10 may be made from any suitable material or material system including, for example, glass, silicon, one or more polymers, or any other suitable material or material system, or combination of materials or material systems. At least some of microfluidic cartridge 10 may be formed of an acrylic material.

In some instances, microfluidic cartridge 10 may include a microfluidic channel 12. While a single microfluidic channel is illustrated, it will be appreciated that microfluidic cartridge 10 may include two or more microfluidic channels, reservoirs, and/or other structures as appropriate. As illustrated, microfluidic channel 12 extends from a first location 14 within microfluidic cartridge 10 to a second location 16 within microfluidic cartridge 10. It will be appreciated that microfluidic channel 12 is intended to generically represent a variety of possible internal fluid passageways and the like that may be included in microfluidic cartridge 10. In some cases, the microfluidic channel 12 may extend out the side of the microfluidic cartridge 10 to, for example, receive a sample, a reagent or other fluid, depending on the application.

Microfluidic channel 12 may be formed in any suitable manner. In some cases, microfluidic cartridge 10 is formed by sandwiching together a number of distinct layers. For example, microfluidic channel 12 may be formed via an elongate aperture formed within a particular layer(s). The top and bottom of microfluidic channel 12 may be formed by the layers immediately above and below the particular layer(s) including the elongate aperture. In this, reference to up and down are relative and refer only to the illustrated orientation. In some cases, at least some of the layers forming microfluidic cartridge 10 may be polymeric, but this is not required in all embodiments.

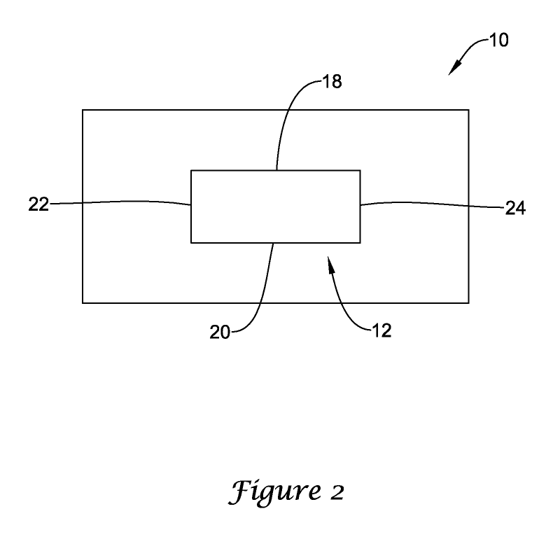

FIG. 2 is a cross-sectional view of the illustrative microfluidic cartridge 10, taken along line 2-2 of FIG. 1. Microfluidic channel 12 may be seen, in the illustrated orientation, as having an upper surface 18 and a lower surface 20. Microfluidic channel 12 may also be considered as including a left side channel wall 22 and a right side channel wall 24. In some cases, microfluidic channel 12 may be considered as having a length that is in the range of several millimeters to several tens of millimeters and a cross-sectional dimension that is in the range of about 1 to about 50 or 100 micrometers. While not expressly seen in FIG. 2, it will be appreciated that microfluidic channel 12 may have a first end corresponding to first location 14 (FIG. 1) and a second end corresponding to second location 16 (FIG. 1), although in some cases microfluidic channel 12 may start or stop adjacent to other internal structures such as reservoirs, valves, pumps and the like, or may extend out the side of the microfluidic cartridge 10 to, for example, receive a sample, a reagent or other fluid, depending on the application.

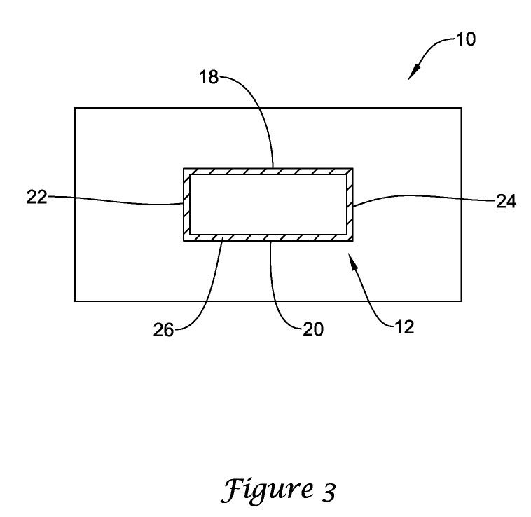

In some cases, a polymer coating may be placed on one or more of the surfaces forming microfluidic channel 10. As best shown in FIG. 3, a polymeric coating 26 can be seen as coating each of upper surface 18, lower surface 20, left side channel wall 22 and right side channel wall 24 of channel 12. Polymeric coating 26 may be quite thin, so as to not excessively decrease the internal size of microfluidic channel 12. It is contemplated that polymeric coating 26 may have an average thickness that is in the nanometer range, but this is not required. In some cases, polymeric coating 26 may be formed by coating appropriate portions of one or more of the layers forming microfluidic cartridge 10, as discussed above. While FIG. 3 shows each side of microfluidic channel 12 bearing polymeric coating 26, it will be appreciated that in some cases only one or a few of the internal surfaces of microfluidic channel 12 may be coated with polymeric coating 26.

Polymeric coating 26 may be formed of any suitable polymer. In some cases, polymeric coating 26 may include a polymer that has a sufficient adhesion to the material forming microfluidic channel 12. In some instances, the polymeric coating 26 may be selected to have appropriate spectral transmission properties, i.e., to have spectral transmission properties similar to the adjacent materials forming microfluidic channel 12 so that the polymeric material does not negatively impact optical excitation and/or examination of fluids within microfluidic channel 12. In some cases, the polymeric coating 26 may be selected to have low solubility in the fluids that are expected to be present within microfluidic channel 12, and/or to be sufficiently adhered to the surfaces such that the polymer resists dissolution into the fluid. It will be appreciated that materials dissolving into the fluid may negatively impact test results by, for example, lysing cells within the fluid.

In some cases, polymeric coating 26 may be formed by coating desired surfaces within microfluidic channel 12 (or surfaces that will form microfluidic channel 12 once all of the layers have been assembled together) with an appropriate polymer dissolved in a suitable solvent, followed by permitting the solvent to dry, thus leaving a polymeric film or coating. A suitable solvent is one that readily dissolves the polymeric material that will form polymeric coating 26 but does not appreciably dissolve the other materials used to form microfluidic cartridge 10. To illustrate, the solvent may be a lower alcohol such as methanol, ethanol, propanol, or butanol, but this is not required in all cases.

In some instances, polymeric coating 26 may be formed from an amphiphilic polymer. Amphiphilic polymers may include hydrophilic portions and hydrophobic portions. The hydrophobic portions may, in some cases, help anchor the polymer to the substrate while the hydrophilic portions may aid the flow of aqueous fluids through the microfluidic channel 12.

In some instances, a useful amphiphilic polymer may be a block copolymer having two or more blocks, with each block having the general chemical structure -(AO)ₓ, where AO represents an oxyalkylene moiety and x is a number that may be in the range of about 1 to about 100. In one block, for example, AO may represent an ethylene oxide moiety while in a second block, AO may represent a propylene oxide moiety. In some cases, a useful amphiphilic polymer may be a polyalkylene oxide block copolymer that may be derived from alkylene oxides such as ethylene oxide, propylene oxide, butylene oxide and the like.

Useful polymers may include a polyethylene oxide block which is relatively hydrophilic combined with another polyalkylene oxide block which is typically hydrophobic. Examples of suitable polyalkylene oxides for forming the hydrophobic block include but are not limited to propylene oxide and butylene oxide. The hydrophobic portion may help bond the polymer to the substrate while the hydrophilic portion may help reduce surface tension within the channel. As a result, fluid flow through the channel may exhibit improved flow patterns and/or may exhibit reduced or no bubble formation.

In some cases, a useful polymer is a triblock copolymer that has a center block of polyoxypropylene units (PO) and a block of polyoxyethylene (EO) units to each side of the center PO block. Examples of these materials are commercially available under the tradename Pluronics™ from the BASF Wyandotte Corporation, and are available under other trademarks from other chemical suppliers. An exemplary polymer is Pluronics™ F127, which is a block copolymer having a center block of about 56 polyoxypropylene units flanked by two end blocks each having about 101 polyoxyethylene units.

In some cases, reverse Pluronics™ may also be useful. These are materials that have a center block of polyoxyethylene units that is flanked on either side with end blocks of polyoxypropylene units. In some cases, useful block copolymers may have two or more blocks of polyoxyethylene units and two or more blocks of polypropylene units arranged, for example, in alternating fashion.

### EXAMPLES

A microfluidic cartridge having a microfluidic channel was provided. The inner surfaces of the microfluidic channel were composed of an acrylic material. A polymeric coating was added to the inner surfaces of the microfluidic channel. The polymeric coating was applied by contacting the microfluidic channel with a dilute solution of PLURONIC™ F127 dissolved in methanol. The coating was allowed to dry. PLURONIC™ F127 is a block copolymer having a center block of about 56 polyoxypropylene units flanked by two end blocks each having about 101 polyoxyethylene units. It is believed that the hydrophobic polyoxypropylene units bonded to the acrylic material forming the microfluidic channel.

A blood sample was provided within the channel. No visible bubbles were seen. In a comparative example, a similar blood sample was provided in a similar channel that did not include the polymeric coating. Bubbles were visible in the channel lacking the polymeric coating.

In a second comparative example, a microfluidic channel was coated using SDS dissolved in a solvent. SDS (sodium dodecyl sulfate) is an anionic, non-polymeric, surfactant. There were problems with the SDS recrystallizing. Moreover, once a blood sample was provided, the SDS tended to re-dissolve into the blood sample and lysed cells within the blood sample.

The disclosure should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

We claim:

1. A microfluidic cartridge comprising:
a channel for transporting a fluid from a first location in the microfluidic cartridge to a second location in the microfluidic cartridge, the channel comprising a channel surface; and
a polymeric coating disposed on the channel surface.

2. The microfluidic cartridge of claim 1, wherein the polymeric coating bonds well to the channel surface.

3. The microfluidic cartridge of claim 1, wherein the channel surface comprises one or more of a bottom channel wall, a top channel wall, a first side channel wall and a second side channel wall.

4. The microfluidic cartridge of claim 3, wherein the polymeric coating comprises an amphiphilic surfactant.

5. The microfluidic cartridge of claim 4, wherein the polymeric coating comprises a polymer having a hydrophobic portion that bonds well to the channel surface and a hydrophilic portion that provides a reduced surface tension to the channel.

6. The microfluidic cartridge of claim 4, wherein the polymeric coating comprises a block copolymer having a hydrophobic block and a hydrophilic block.

7. The microfluidic cartridge of claim 4, wherein the polymeric coating comprises a block copolymer having a poly(ethylene oxide) block and a poly(propylene oxide) block.

8. The microfluidic cartridge of claim 4, wherein the polymeric coating comprises a block copolymer having a central polypropylene oxide block) flanked by first and second poly(ethylene oxide) blocks.

9. The microfluidic cartridge of claim 8, wherein the central poly(propylene oxide) block comprises about 56 propylene oxide repeating units and the first and second poly(ethylene oxide) blocks each comprise about 101 ethylene oxide repeating units.

10. A microfluidic cartridge comprising:
a polymeric substrate;
a channel formed within the substrate, the channel comprising a channel surface; and
a polymer coating on the channel surface, the polymer coating formed from a block copolymer having a hydrophobic portion that bonds to the channel surface and a hydrophilic portion that reduces surface tension of the channel surface.

11. The microfluidic cartridge of claim 10, wherein the channel surface comprises one or more of a bottom channel wall, a top channel wall, a first side channel wall and a second side channel wall.

12. The microfluidic cartridge of claim 10, wherein the polymeric coating comprises a block copolymer having a poly(ethylene oxide) block and a poly(propylene oxide) block.

13. The microfluidic cartridge of claim 10, wherein the polymeric coating comprises a block copolymer having a central poly(propylene oxide) block flanked by first and second poly(ethylene oxide) blocks.

14. The microfluidic cartridge of claim 10, wherein the central poly(propylene oxide) block comprises about 56 propylene oxide repeating units and the first and second poly(ethylene oxide) blocks each comprise about 101 ethylene oxide repeating units.

15. A microfluidic cartridge comprising:
a channel for transporting a fluid from a first location in the microfluidic cartridge to a second location in the microfluidic cartridge, the channel comprising a channel surface;
a polymeric coating disposed on the channel surface; and
an aqueous fluid disposed within the channel, the aqueous fluid being free or substantially free of bubbles.

16. The microfluidic cartridge of claim 15, wherein the polymeric coating comprises a polymer having a hydrophobic portion that bonds well to the channel surface and a hydrophilic portion that provides a reduced surface tension to the channel.

17. The microfluidic cartridge of claim 15, wherein the polymeric coating comprises a block copolymer having a hydrophobic block and a hydrophilic block.

18. The microfluidic cartridge of claim 15, wherein the polymeric coating comprises a block copolymer having a poly(ethylene oxide) block and a poly(propylene oxide) block.

19. The microfluidic cartridge of claim 15, wherein the polymeric coating comprises a block copolymer having a central poly(propylene oxide block) flanked by first and second poly(ethylene oxide) blocks.

20. The microfluidic cartridge of claim 15, wherein the central poly(propylene oxide) block comprises about 56 propylene oxide repeating units and the first and second poly(ethylene oxide) blocks each comprise about 101 ethylene oxide repeating units.
